(19) United States
(12) Patent Application Publication
(10) Pub. No.: US 2026/0211875 A1
(43) Pub. Date: Jul. 23, 2026

(54) SYSTEM AND METHOD FOR CATEGORIZATION AND POST-PROCESSING IN TEXT-TO-SQL USING AN LLM

(71) Applicant: Nice Ltd., Ra'anana (IL)

(72) Inventors: Peter LIFSHITS, Kedumim (IL); Karthik CHANDRASHEKARAN, Pune (IN)

(73) Assignee: Nice Ltd., Ra'anana (IL)

(21) Appl. No.: 19/026,804

(22) Filed: Jan. 17, 2025

(51) Int. Cl. G06F 16/2452; G06F 16/21; G06F 16/28

(52) U.S. Cl. CPC G06F 16/24522; G06F 16/211; G06F 16/285

(57) ABSTRACT

A system and method for an improved text to structured query language (SQL) for use with a large language model (LLM). Categories of possible questions for a database can be determined and a mapping between the data elements of the database and the categories can be determined. User questions can have a match level to the categories. Data elements from a data schema can be removed that do not match categories according to the match level, the modified data schema can be used for the database with the LLM.

### TECHNICAL FIELD OF THE INVENTION

The present disclosure relates generally to large language models (LLMs) and other artificial intelligence (AI) systems and models, and more specifically to a system and method for automatically generating structured data queries (e.g., prompts) from natural language questions using an LLM.

### BACKGROUND OF THE INVENTION

Currently, large datasets (e.g., up to millions of records) can be used to generate analytic information (e.g., graphs, dashboards and/or plots) that a user is interested in. Typically, developers design and program tools to analyze the large datasets. Often, the program tools (e.g., dashboards) can be configurable, however, they often lack flexibility that allows for particular desired analysis. For example, contact centers that have agents interacting with customers can collect data on customer/agent interaction. Assume that a particular team of agents has an increase in problematic calls, current systems can provide a fixed set of metrics related to performance (e.g., average handle time, after-call work, and/or percentage of resolved calls). However, it can be desired to have flexibility to specify metrics to be analyzed. For example, assume for the team of agents with an increase in problematic calls, a desired inquiry of an average satisfaction score among calls that lasted more then eight minutes and only on weekends be provided. Currently, this level of specificity in queries typically cannot be accommodated in real time. Instead, typically, a developer has to receive and program the specific query for the desired analysis.

Some companies have started using LLMs to provide a free text interface that can use the large datasets to answer questions. However, users typically do not understand how to generate prompts that yield the analysis they are looking for and/or are unfamiliar with what is available inside of the dataset.

Typically, when using an LLM with a large dataset, the inquire that is in a natural language form is translated to a structured query language (SQL) that can access and manipulate the large databases. When using a LLM to translate natural language to structured query language (SQL), a data schema for the SQL can be provided in a LLM prompt along with a natural language user question. The LLM can figure out which tables/columns in a database are to be used in the resulting SQL. However, the resulting SQL often turns out incorrect and not what the user intended.

One difficulty is that large database data schemas often contain many tables and columns, with relatively short and/or ambiguous names or descriptions. As a result, LLMs often have errors in what tables or columns to pick even when the data schema is provided.

Another difficulty is that in some data schemas the data can have domain-specific organization logic, which the LLM has no way of knowing, since domain-specific organization logic is not part of data schemas. For example, in a contact center dataset a query about hold time typically only relates to interactions over voice-based channels however text or email channels can also be relevant. In another example, a query about average of after-call-work time typically ignores records of refused calls. An LLM has no way of knowing all such domain-specific logic to include relevant filters while generating the SQL. Domain-specific logic is typically very dataset specific because each organization can design their own complex datasets differently.

Therefore, it can be desirable to provide an ability to have a system that allow for flexible query generation in real-time using natural language.

### SUMMARY OF THE INVENTION

Advantages of the invention can include real-time metric definition for analysis without recoding systems for each new metric using natural language. Advantages of the invention can also include reducing the rate of incorrect results due to, for example, LLM misunderstanding and/or misinterpretation.

In one aspect, the invention involves a method for an improved text to structured query language (SQL) for use with a large language model (LLM). The method can involve determining, by a computer, a plurality of categories of possible questions for a database that is to be used with the LLM. The method can involve determining, by the computer, a mapping between each data element in the database and one or more of the plurality of categories by the LLM. The method can involve receiving, by the computer, a user question. The method can involve determining, by the computer, a match level for the user question to each of the plurality of categories using an LLM. The method can involve removing, by the computer, all data elements from a data schema for the database having a mapped category that has a match level of does not match. The method can involve using, by the computer, the modified data schema for the database with the LLM to answer the user question. The method can involve transmitting, by the computer, the answer to a display.

In some embodiments, determining the plurality of categories further involves inputting a data schema for the database into the LLM and transmitting a request to the LLM to cluster tables and columns of the database into categories.

In some embodiments, each of the plurality of categories comprises a category identification number, a category name, a category description, one or more SQL filters associated with the categories, or any combination thereof.

In some embodiments, the method further involves using, by the computer, the modified data schema for the database with the LLM to translate user question to SQL. In some embodiments, the method further involves applying a filter to the SQL when a category for the user question has an associated filter.

In another aspect, the invention involves a system for an improved text to structured query language (SQL) for use with a large language model (LLM). The system can include a database that includes data to be used with the LLM. The system can also include a processor configured to determine a plurality of categories of possible questions for the database that is to be used with the LLM. The processor can also be configured to determine a mapping between each data element in the database and one or more of the plurality of categories by the LLM. The processor can also be configured to receive a user question and determine a match level for the user question to each of the plurality of categories using an LLM. The processor can also be configured to remove all data elements from a data schema for the database having a mapped category that has a match level of does not match. The processor can also be configured to use the modified data schema for the database with the LLM to answer the user question and transmit the answer to a display.

In some embodiments, determining the plurality of categories further causes the processor to input a data schema for the database into the LLM and transmit a request to the LLM to cluster tables and columns of the database into categories.

In some embodiments, each of the plurality of categories comprises a category identification number, a category name, a category description, one or more SQL filters associated with the categories, or any combination thereof

In some embodiments, the processor is further configured to use the modified data schema for the database with the LLM to translate user question to SQL.

In some embodiments, the processor is further configured to apply a filter to the SQL when a category for the user question has an associated filter.

In another aspect, the invention can include a non-transitory computer program product comprising instruction which, when the program is executed cause the computer to determine a plurality of categories of possible questions for a database that is to be used with a LLM. The non-transitory computer program product can further comprise, when the program is executed cause the computer to determine a mapping between each data element in the database and one or more of the plurality of categories by the LLM. The non-transitory computer program product can further comprise, when the program is executed cause the computer to receive a user question. The non-transitory computer program product can further comprise, when the program is executed cause the computer to determine a match level for the user question to each of the plurality of categories using an LLM. The non-transitory computer program product can further comprise, when the program is executed cause the computer to remove all data elements from a data schema for the database having a mapped category that has a match level of does not match. The non-transitory computer program product can further comprise, when the program is executed cause the computer to use the modified data schema for the database with the LLM to answer the user question. The non-transitory computer program product can further comprise, when the program is executed cause the computer to transmit the answer to a display.

In some embodiments, determining the plurality of categories further includes instructions to cause the computer to input a data schema for the database into the LLM. And transmit a request to the LLM to cluster tables and columns of the database into categories.

In some embodiments, each of the plurality of categories comprises a category identification number, a category name, a category description, one or more SQL filters associated with the categories, or any combination thereof. In some embodiments, the processor is further configured to use the modified data schema for the database with the LLM to translate user question to SQL.

In some embodiments, the processor is further configured to apply a filter to the SQL when a category for the user question has an associated filter.

These, additional, and/or other aspects and/or advantages of the present invention may be set forth in the detailed description which follows; possibly inferable from the detailed description; and/or learnable by practice of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device which may be used with embodiments of the present invention.

FIG. 2 is flowchart for an improved text to structured query language (SQL) for use with a large language model (LLM),, according to some embodiments of the invention.

FIG. 3 is an example of a system architecture for determining a plurality of categories, according to some embodiments of the invention.

FIG. 4A is an example of an SQL created with an LLM for a database based on a data schema without any categorization of the data schema, according to the prior art.

FIG. 4B shows an example of an SQL created with the LLM for the database of FIG. 4A based on a data schema with categorization of the data schema, according to some embodiments of the invention.

FIG. 5 is a system architecture 500 for an improved text to structured query language (SQL) for use with a large language model (LLM), according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

As used herein, “machine learning”, “machine learning algorithms”, “machine learning models”, “ML”, or similar, may refer to models built by algorithms in response to/based on input sample or training data. ML models may make predictions or decisions without being explicitly programmed to do so. ML models require training/learning based on the input data, which may take various forms.

ML models may, for example, include Large Language Models (LLM) such as Generative Pre-Trained Transformer (GPT), Bidirectional Encoder Representations from Transformers (BERT), Pathways Language Model (PaLM) and the like, (artificial) neural networks (NN), decision trees, regression analysis, Bayesian networks, Gaussian networks, genetic processes, etc. Additionally, or alternatively, ensemble learning methods may be used which may use multiple/modified learning algorithms, for example, to enhance performance. Ensemble methods, may, for example, include “Random forest” methods or “XGBoost” methods.

Neural networks (NN) (or connectionist systems) are computing systems inspired by biological computing systems but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10s or even 100s of Teraflops, or a large set of cores. On modern GPUs this can be done using 4,000-5,000 cores.

It will be understood that any subsequent reference to “machine learning”, “machine learning algorithms”, “machine learning models”, “ML”, or similar, may refer to any/all of the above ML examples, as well as any other ML models and methods as may be considered appropriate.

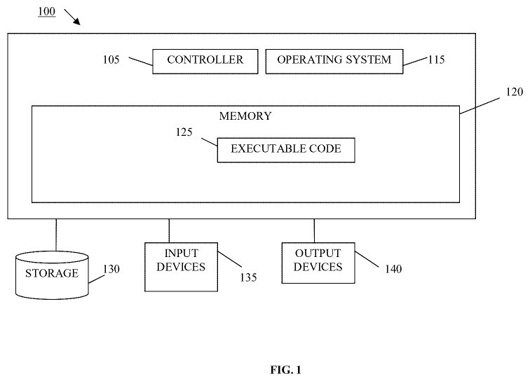

FIG. 1 shows a high-level block diagram of an exemplary computing device which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of modules, methods and equipment and other devices and modules discussed herein, may be or include, or may be executed by, a computing device such as included in FIG. 1 although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or data.

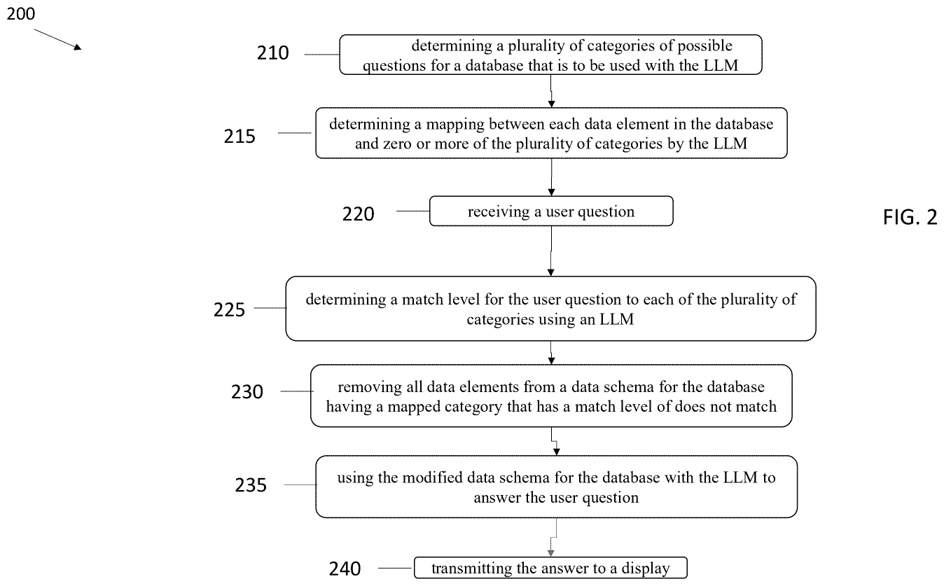

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIG. 2 or other figures, or other methods, according to embodiments of the present invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by, for example, executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

FIG. 2 is flowchart for a method for an improved text to structured query language (SQL) for use with a large language model (LLM), according to some embodiments of the invention.

The method can involve determining (e.g., by a computer as described above in FIG. 1) a plurality of categories of possible questions for a database that is to be used with the LLM (Step 210). Each category can include a category identifier, a category name, a category description and/or associated SQL filters to apply to queries.

In some embodiments, the categories can be input by a user. In some embodiments, the categories are determined automatically (e.g., the categories are not input by the user and/or if queries are made where current categories aren't applicable).

In some embodiments, for a user inputting the categories, the user is typically aware of the distinct and separate data domains represented in the data schema. The user questions can, cover more than one domain. In some embodiments, types of questions that can require distinct groups of columns to answer can be determined. For example, in a database representing analytical data of a contact center, questions about agents performance (such as handle time or time in queue) can require one set of columns, while questions about agents desktop activity (e.g., applications used, types and/or durations) can be a different set of columns.

In some embodiments, categories can have filters applied. For example, for a set of records having no meaningful values in some of the columns, but still sit in the same table with other records that do, the records without meaningful values can be filtered. For example, assume a category of “handing voice calls” with a filter of “where channel name=‘phone call’, the filter can remove all entries that have phone calls from the category. In another example, wait time in queue is may not be relevant for analyzing outbound calls made by agent to customer, such that when analyzing wait time outbound calls can be filtered. In another example, an average of wait time in queue typically only the inbound calls are relevant, thus, a filter can be applied for.

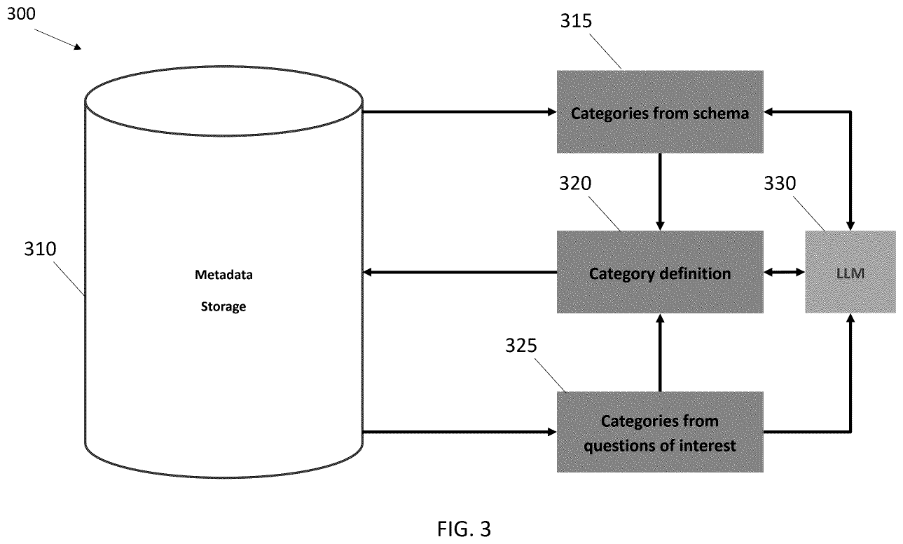

In some embodiments, determining the plurality of categories automatically is performed as described below in FIG. 3.

The categories in a workforce management system domain can be agent behavioral metrics, digital channels handling and/or call intent/outcome.

The method can also involve determining a mapping between each data element in the database and one or more of the plurality of categories by the LLM (Step 215).

In some embodiments, a user question might belong to more than one category.

The method can also involve determining receiving a user question (Step 220).

The method can also involve determining a match level for the user question to each of the plurality of categories using an LLM (Step 225). A prompt for the LLM can be determined based on the user question. For example, “Given the following question, set a score from 0 to 100 signifying how much that question belongs to each of the following categories. Categories are not exclusive, they often overlap. Output a JSON list of objects each with category and its score. Question: {question}. Categories: {list of categories}.” The score can be used to determine the match level.

For a score between 0 and 20, the match level can be “surely belongs to.” For a score between 80 and 100, the match level can be “surely does not belong to,” and for a match level between 20 to 80, the match level can be “not confident enough.” The score that corresponds to each match level can be set by a user. For example, a score between 0 and 30, the match level can be “surely belongs to.”

The method can also involve removing all data elements from a data schema for the database having a mapped category that has a match level of does not match (“e.g., surely does not belong to”) (Step 230). In some embodiments, the method involves removing all data elements from the data schema for the database having a mapped category that have a match level other than “surely belongs to.”

The data schema can be a list of tables having columns that describe data in a database. Each column in the data schema can have a column name, column type, column description and/or a list of category identifiers.

In some embodiments, all data elements (e.g., questions) for the database that have no mapped category can be stored to use in determining categories when a predefined category is not available. For example, the data element with no mapped category can be used to create additional categories.

The method can also involve using the modified data schema for the database with the LLM to answer the user question (Step 235). The modified data schema can be the data schema with the elements removed from Step 230, and can be smaller in size then the original data schema. Having a modified data schema that is smaller than the original data schema can result in a reduced chance of the LLM producing erroneous results due to, for example, elimination of sources of ambiguity.

The method can also involve transmitting the answer to a display (Step 240).

FIG. 3 is an example of a system architecture 300 for determining a plurality of categories, according to some embodiments of the invention.

The system architecture 300 can include a metadata storage 310, a categories from schema module 315, a category definition module 320, a categories from questions of interest module 325, and a LLM 330.

The metadata storage 310 can store data schemas, questions of interest, and/or categories.

The categories from schema module 315 can communicate with the metadata storage 310, the category definition module 320 and the LLM 330. During operation, the categories from schema module 315 can retrieve from the metadata storage 310 all of the data schema and a list of existing categories (if any). The metadata storage 310 can be a single database that has multiple tables, each with its own schema. The categories from schema module 315 can create a LLM prompt based on the data schema. For example, the prompt can be: “Here is a schema of a DB: {Schema}. Here are the categories of questions that are already defined: {categories}. Please provide up to N new different categories of questions a business analyst might want to ask about the data in the database. Different categories mean different from existing and targeting a group of tables/columns as separate as possible,” where N is an integer greater then one. The categories from schema module 315 can send the prompt to the LLM 330. The LLM 330 can return the results of answering the prompt back to the categories from schema module 315. The categories from schema module 315 can send the results to the category definition module 320.

The categories from schema module 315 can execute once initially, at a predetermined periodic frequency (e.g., once a week), when the schema changes or any combination.

The categories from questions of interest module 325 can communicate with the metadata storage 310, the category definition module 320 and the LLM 330. During operation, the categories from questions of interest module 325 can retrieve from the metadata storage 310 all of the data schema and a list of questions. The categories from schema module 315 can create an LLM prompt based on the data schema. The prompt can be: “Here is a schema of a DB: {Schema}. Here is a list of questions asked about data in the DB: {list of questions}. Please identify one or more distinct categories of questions. Distinct categories mean targeting a group of tables/columns as separate as possible.”

The categories from questions of interest module 325 can send the prompt to the LLM 330. The LLM 330 can return the results of answering the prompt back to the categories from questions of interest module 325. The categories from questions of interest module 325 can send the results to the category definition module 320.

The list of questions can be questions that do not fit within the existing categories. The categories from questions of interest module 325 can execute when a number of questions that do not fit within the existing categories meets a predefined threshold (e.g., as input by a user or dependent upon the size of the database), at a predetermined periodic frequency (e.g., once a week), or both.

The category definition module 320 can communication with the communicate with the metadata storage 310, the categories from schema module 315, the categories from questions of interest module 325 and the LLM 330.

During operation, the category definition module 320 can for each of the categories, create a prompt. The prompt can be “Here is a schema of a DB: {schema}. Please list the columns which will be relevant or useful in an SQL for answering questions of the following category: {category}.” The category definition module 320 can sent the prompt to the LLM 330. The LLM 330 can return the results of answering the prompt back to the category definition module 320. The category definition module 320 can create one or more new categories, including a newly generated identifier(s) and send the results to the metadata storage 310. In some embodiments, the columns associated to the new categories can be added to the data schema.

In some embodiments, the results of the LLM 330 can be analyzed to determine if the columns associated to the categories by the LLM 3300 are valid. The analysis can include verifying the logic of the association based on domain data knowledge and/or adding filters. In some embodiments, the analysis is performed by another system.

The LLM 330 can be generative large language models that are capable of semantic classification (e.g., for determining the category and/or translation to free text to structure query (SQL), e.g., GPT or Claude), [ ].

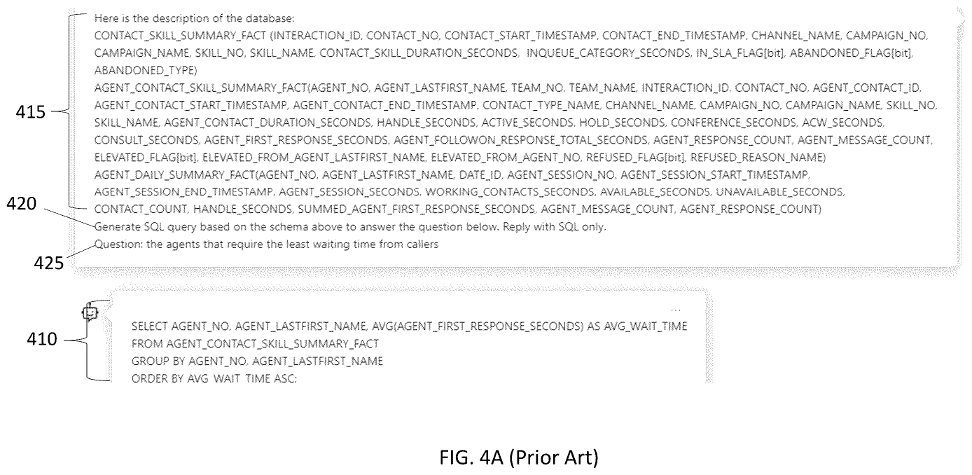

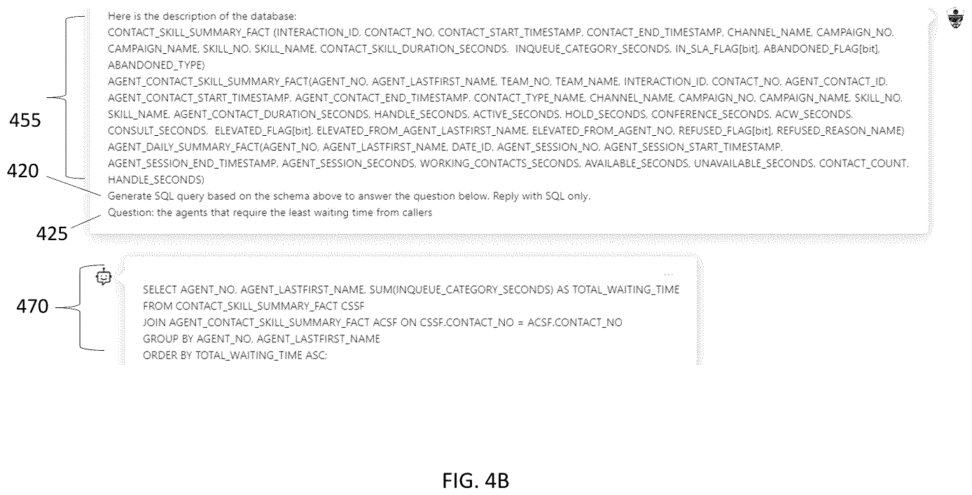

FIG. 4A is an example of an SQL 410 created with an LLM (e.g., LLM 330 as described above) for a database (not shown) based on a data schema 415 without any categorization of the data schema, having prompt 420 and question 425, according to the prior art. The SQL includes (Agent_First_Response_Seconds) which is only relevant to digital channels. Question 425 requests waiting time from callers, thus output that is only relevant to digital channels is incorrect.

Applying the categorization methods as described above in FIG. 2 and FIG. 3 to the example shown FIG. 4A can results FIG. 4B. FIG. 4B shows an example of an SQL 470 created with an LLM (e.g., LLM 330 as described above) for the database of FIG. 4A based on a data schema 445 with categorization of the data schema, having the prompt 420 and the question 425, according to some embodiments of the invention.

The prompts to the LLM to categorize can be as follows:
“Given a question below, set a score from 0 to 100 signifying how much that question belongs to each of the following categories. Categories are not exclusive, they often overlap. Reply only with list of categories and their scores. Question: the agents that require least waiting time from callers. Categories: Agent behavioural metrics (describes the sentiment and behaviour of agents); Autosummary analysis (describes call reason and outcome, resolution status and customer satisfaction; Call statistics (describes call times, flags for dropped, refused, in SLA, elevated); Handling of digital channels (metrics for handling contacts via whatsapp, mail and alike, meaning not phone voice calls; Calls answered by agents (relevant for questions on handling time, acw, agent behaviour metrics); Calls over voice channel (relevant for questions on waiting in queue, dropped calls).

The question 425 surely belongs to “Calls over voice channels“ and surely does not belong to ”Handling of digital channels,“ ”Agent behavioral metrics,“ and ”Autosummary analytics.”

The results of sending the prompts and question above to the LLM can be “Agent behavioural metrics: 0; Autosummary analysis: 0; Call statistics: 70; Handling of digital channels: 0; Calls answered by agents: 30; Calls over voice channel: 100.

In some embodiments, filters can be applied. The filters can be specific to the categories. In some embodiments, a prompt can be given to the LLM including the category, schema and a question to the LLM as to whether any filter should be applied.

For example, assume a question “what percentage of calls are abandoned by callers,” for a particular database that has a query generated without categorization and/or filter, results in a generated query that counts interactions marked by an abandon flag divided by a total interactions including chats. Assume the same question with categorization as described above applied, the question can belong to a defined category of “handling voice calls.” Assume the category of “handling voice calls” has a corresponding filter that specifies the communication channel field can be “phone call”, then the filter can be added to the query generated to cause a correct query.

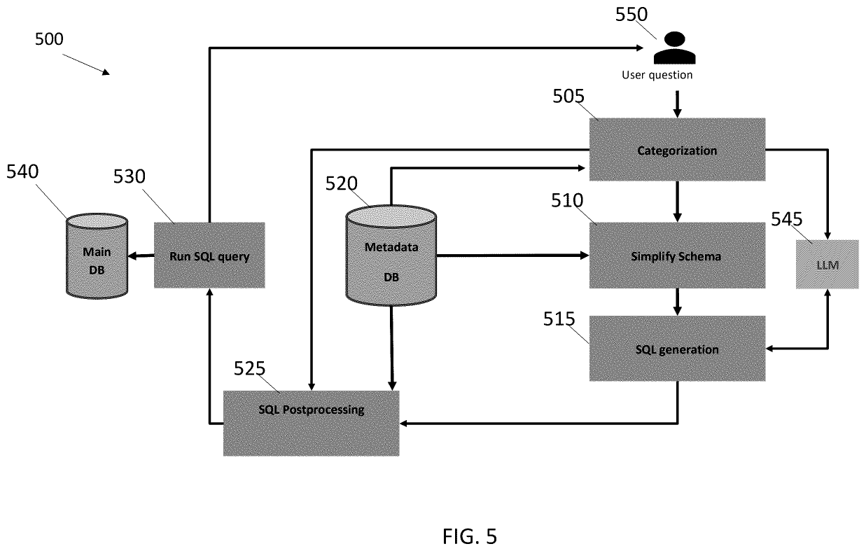

FIG. 5 is a system architecture 500 for an improved text to structured query language (SQL) for use with a large language model (LLM), according to some embodiments of the invention.

The system architecture can include a categorization module 505, a simply schema module 510, a SQL generation module 515, a metadata database 520, SQL post processing 525, run SQL query 530, main database 540, a LLM 545 and a user 550.

The user 550 can transmit questions to the system (e.g., via a graphical user interface).

The categorization module 505 can obtain a list of defined categories with their description (e.g., as described above with respect to FIG. 2) from the metadata database 520. The categories and the user question can be input to populate a prompt. The prompt can request from the LLM a score for each category wherein the score indicates relevancy of the category to the question. The prompt can be as described above with respect to FIG. 2.

The simplify schema module 510 can retrieve the full data schema from the metadata database 520. The simplify schema module 510 can receive the list of categories that the question surely does not belong too from the categorization module 505. The simplify schema module 510 can go over columns (or rows depending on how the schema is organized) and delete each column that has a match level of “surely does not belong” to create a modified data schema.

The SQL generation module 515 can receive the modified data schema from the simplify schema modules 510. The SQL generation module 515 can generate a prompt to cause the LLM 545 to translate the modified data schema and the question to a SQL. For example, the prompt can be “Here is the full schema {modified data schema}, here is the question {question}, please translate the question to SQL.” The prompt can be sent to the LLM 545. The LLM 545 can transmit the result, the SQL to the SQL generation module 515.

The SQL postprocessing module 525 can retrieve the list of categories from the categorization module 505 and filters for list of categories from the metadata database 520. The SQL postprocessing module 525 can receive the SQL from the SQL generation module 515. In various embodiments, filters are not used or some categories have no filters. The SQL postprocessing module 525 can apply any retrieved filters to the SQL. The SQL postprocessing module 525 can send the SQL to the run SQL query module 530.

The run SQL query module 530 can run the resulting SQL against the main database 540 that holds the data that the user's question relates to.

The aforementioned flowcharts and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit,” “module” or “system.”

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

1. A method for an improved text to structured query language (SQL) for use with a large language model (LLM), the method comprising:
determining, by a computer, a plurality of categories of possible questions for a database that is to be used with the LLM;
determining, by the computer, a mapping between each data element in the database and one or more of the plurality of categories by the LLM;
receiving, by the computer, a user question;
determining, by the computer, a match level for the user question to each of the plurality of categories using an LLM;
removing, by the computer, all data elements from a data schema for the database having a mapped category that has a match level of does not match;
using, by the computer, the modified data schema for the database with the LLM to answer the user question; and
transmitting, by the computer, the answer to a display.

2. The method of claim 1 wherein determining the plurality of categories comprises:
inputting a data schema for the database into the LLM; and
transmitting a request to the LLM to cluster tables and columns of the database into categories.

3. The method of claim 1 wherein each of the plurality of categories comprises a category identification number, a category name, a category description, one or more SQL filters associated with the categories, or any combination thereof.

4. The method of claim 1 further comprising using, by the computer, the modified data schema for the database with the LLM to translate user question to SQL.

5. The method of claim 5 further comprising applying a filter to the SQL when a category for the user question has an associated filter.

6. A system for an improved text to structured query language (SQL) for use with a large language model (LLM), the system comprising:
a database that includes data to be used with the LLM; and
a processor configured to:
determine a plurality of categories of possible questions for the database that is to be used with the LLM,
determine a mapping between each data element in the database and one or more of the plurality of categories by the LLM,
receive a user question,
determine a match level for the user question to each of the plurality of categories using an LLM,
remove all data elements from a data schema for the database having a mapped category that has a match level of does not match,
use the modified data schema for the database with the LLM to answer the user question, and
transmit the answer to a display.

7. The system of claim 6 wherein determining the plurality of categories further causes the processor to:
input a data schema for the database into the LLM; and
transmit a request to the LLM to cluster tables and columns of the database into categories.

8. The system of claim 6 wherein each of the plurality of categories comprises a category identification number, a category name, a category description, one or more SQL filters associated with the categories, or any combination thereof

9. The system of claim 6 wherein the processor is further configured to use the modified data schema for the database with the LLM to translate user question to SQL.

10. The system of claim 9 wherein the processor is further configured to apply a filter to the SQL when a category for the user question has an associated filter.

11. A non-transitory computer program product comprising instruction which, when the program is executed cause the computer to:
determine a plurality of categories of possible questions for a database that is to be used with a LLM;
determine a mapping between each data element in the database and one or more of the plurality of categories by the LLM;
receive a user question;
determine a match level for the user question to each of the plurality of categories using an LLM;
remove all data elements from a data schema for the database having a mapped category that has a match level of does not match;
use the modified data schema for the database with the LLM to answer the user question; and
transmit the answer to a display.

11. The non-transitory computer program product 11 wherein determining the plurality of categories further includes instructions to cause the computer to:
input a data schema for the database into the LLM; and
transmit a request to the LLM to cluster tables and columns of the database into categories.

12. The non-transitory computer program product 11 wherein each of the plurality of categories comprises a category identification number, a category name, a category description, one or more SQL filters associated with the categories, or any combination thereof

13. The non-transitory computer program product 11 wherein the processor is further configured to use the modified data schema for the database with the LLM to translate user question to SQL.

14. The non-transitory computer program product 11 wherein the processor is further configured to apply a filter to the SQL when a category for the user question has an associated filter.
